(19) United States
(12) Patent Application Publication
(10) Pub. No.: US 2026/0175272 A1
(43) Pub. Date: Jun. 25, 2026

(54) SENSOR-CLEANING CAMERA BODY CAP SYSTEM

(71) Applicants: William J. Fritsch, Madison, WI (US); Bruce L. Winkler, Madison, WI (US); David Williams, Madison, WI (US)

(72) Inventors: William J. Fritsch, Madison, WI (US); Bruce L. Winkler, Madison, WI (US); David Williams, Madison, WI (US)

(21) Appl. No.: 19/424,962

(22) Filed: Dec. 18, 2025

Related U.S. Application Data
(60) Provisional application No. 63/737,265, filed on Dec. 20, 2024.

(51) Int. Cl. B08B 9/032; B01D 46/00; B01D 46/10; F16K 15/00

(52) U.S. Cl. CPC B08B 9/0328; B01D 46/0041; B01D 46/0047; B01D 46/10; F16K 15/00; B08B 2209/032

(57) ABSTRACT

A system for removing contaminants from the interior of a camera body. In one version, airflow is generated by an external air bulb. An airflow module attaches to a camera body cap and includes an air intake channel, an air intake filter, at least one sensor channel configured to direct filtered air into the camera interior, and at least one air output channel for discharging air. In another version, an air bulb is mounted to the camera body cap, and a filter frame is sealed to the bulb and the cap to form an air chamber. A cap intake channel and an air intake filter supply filtered air to the air chamber, and at least one sensor channel delivers air into the camera body when the bulb is depressed.

### CROSS-REFERENCE TO RELATED APPLICATIONS

Priority is hereby claimed to provisional application Ser. No. 63/737,265, filed Dec. 20, 2024, which is incorporated herein by reference.

### BACKGROUND

Single-lens reflex (SLR) and digital SLR cameras can interchange lenses, and the camera body therefore includes a mounting ring for attaching the various lenses. When no lens is attached, a body cap is typically placed over the opening to inhibit contaminants such as dirt and dust from entering the internal workings of the camera. However, contaminants can still enter the camera body over time and accumulate on sensitive components such as sensors and mirrors. If not removed, the contaminants may appear in captured images. Therefore, maintaining a clean, contaminant-free camera interior is critical.

A common method for removing contaminants is using a bulb-type air blower, in which the user directs an air nozzle into the camera body and expels air by squeezing the flexible bulb. However, this method may inadvertently introduce additional contaminants to the camera interior from the air blown in. Moreover, the airflow may not be sufficiently distributed to remove contaminants from all internal workings of the camera, allowing contaminants to remain or migrate within the camera. The blower device itself can also be easily misplaced.

Thus, there remains an unmet need for a system capable of delivering clean air with even distribution to effectively remove contaminants from the interior of a camera body.

### SUMMARY

The present disclosure is directed to a camera accessory, more specifically to a system for blowing air to clean a camera interior.

Specifically, in one aspect of the disclosure, disclosed and claimed herein is a system for removing contaminants from an interior of a camera body, comprising:
(a) a camera body cap configured to be removably attached to the camera body, the camera body cap having an aperture extending therethrough;
(b) an airflow module coupled to the camera body cap, the airflow module cooperating with the aperture of the camera body cap to form an air intake path configured to receive airflow from an external air bulb and direct the airflow toward the interior of the camera body,
the airflow module comprising:
   (i) an air intake channel configured to receive airflow from the external air bulb;
   (ii) an air intake filter positioned to remove contaminants from incoming air; and
   (iii) at least one sensor channel disposed downstream of the air intake filter and configured to deliver the filtered air into the interior of the camera body; and
(c) at least one air output channel structurally associated with the airflow module and/or the camera body cap, and configured to allow air to exit from the interior of the camera body.

In certain embodiments, the air intake channel houses an air intake check valve configured to permit airflow toward the interior of the camera body and to inhibit backflow. In some embodiments, the air intake check valve is positioned upstream of the air intake filter. In some embodiments, the air intake check valve is positioned downstream of the air intake filter.

In certain embodiments, the system further comprises an output check valve positioned to inhibit backflow of air through the air output channel.

In certain embodiments, components of the airflow module are arranged on opposite sides of the camera body cap, and the at least one sensor channel is located downstream of the aperture.

In one exemplary embodiment, the airflow module comprises a first tubular component and a second tubular component, each having a hollow interior. The first tubular component comprises a first tubular section, a second tubular section, and a base. The second tubular component comprises a tubular section and a base configured to face the interior of the camera body. The tubular section of the second tubular component extends through the aperture of the camera body cap and engages the second tubular section of the first tubular component to form the airflow module.

In this particular embodiment, the air intake filter is positioned at a junction between the first tubular section and the second tubular section of the first tubular component, and the airflow module further comprises an air intake check valve disposed within the assembled tubular components in the airflow path downstream of the air intake filter. The second tubular component comprises at least one sensor channel extending through its base, and at least one air output channel extending through its base at a position radially outward of the at least one sensor channel. The system may further comprise an umbrella check valve disposed within the first tubular component and configured to release excess pressure generated by the external air bulb.

In certain embodiments, the airflow module is attached to an outer surface of the camera body cap such that the at least one sensor channel is located upstream of, or in parallel with, the aperture.

In one exemplary embodiment, the airflow module comprises a tubular component comprising the air intake channel configured to receive the external air bulb. The airflow module further comprises a base component coupled to the tubular component. The base component comprises at least one sensor channel extending through the base component and aligned with the aperture of the camera body cap. The airflow module further comprises at least one air output channel extending through the tubular component and positioned radially outward of the air intake channel, and at least one air output channel extending through the base component and positioned radially outward of the at least one sensor channel. In this particular embodiment, the air intake filter is positioned between the air intake channel and the at least one sensor channel.

In this particular embodiment, the system may further comprise an air output check valve positioned outward to the air output channel of the base component and configured to prevent backflow of air through the air output channel of the base component.

In another aspect of the disclosure, disclosed and claimed herein is a system for removing contaminants from an interior of a camera body, comprising:
(a) a camera body cap configured to be removably attached to the camera body, the camera body cap having an aperture extending therethrough and at least one cap intake channel extending therethrough;
(b) a flexible bulb extending through the aperture of the camera body cap;
(c) a filter frame mounted and sealed to the camera body cap and the air bulb, such that the camera body cap, the air bulb, and the filter frame together form an air chamber;
(d) an air intake filter positioned between the at least one cap intake channel and the filter frame to remove contaminants from air drawn through the cap intake channel; and
(e) at least one sensor channel extending through a base of the filter frame and configured to place the air chamber in fluid communication with the interior of the camera body;
wherein depression of the air bulb generates airflow from the air chamber through the sensor channel into the interior of the camera body and expels air therefrom, and release of the air bulb draws air through the cap intake channel, the air intake filter, and the sensor channel into the air chamber.

In certain embodiments, the system further comprises a secondary air filter positioned between the air chamber and the at least one sensor channel.

In certain embodiments, the at least one cap intake channel is configured to conduct airflow out of the interior of the camera body during depression of the air bulb and to conduct airflow into the air chamber during release of the air bulb.

In certain embodiments, the system further comprises at least one frame intake channel extending through the filter frame, and an intake valve positioned along the frame intake channel and configured to allow airflow into the air chamber during release of the air bulb and inhibit airflow during depression of the air bulb.

In certain embodiments, the system further comprises at least one frame output channel extending through the filter frame, and an output valve positioned along the frame output channel and configured to allow air to exit the camera body during depression of the air bulb and inhibit airflow during release of the air bulb.

The objects and advantages of the invention will appear more fully from the following detailed description of the preferred embodiment of the invention made in conjunction with the accompanying drawings.

### BRIEF DESCRIPTION OF THE DRAWINGS

FIGS. 1A and 1B show a front perspective view (FIG. 1A) and rear perspective view (FIG. 1B) of a first exemplary embodiment of the camera body cap system.

FIG. 2 shows a side view of the first exemplary embodiment of the camera body cap system.

FIG. 3 shows a cross-sectional view of the first exemplary embodiment of the camera body cap system taken from line 3-3 as shown in FIG. 2.

FIG. 4 shows an exploded view of the first exemplary embodiment of the camera body cap system.

FIG. 5 shows the first exemplary embodiment installed on a camera and operated with an external air bulb.

FIGS. 6A and 6B show a side view of the first tubular component of the first exemplary embodiment (FIG. 6A) and a cross-sectional view taken from line 6B-6B of the side view (FIG. 6B).

FIGS. 7A and 7B show a rear view (FIG. 7A) and side view (FIG. 7B) of the second tubular component of the first exemplary embodiment of the camera body cap system.

FIGS. 8A and 8B show a front perspective view (FIG. 8A) and rear perspective view (FIG. 8B) of a second exemplary embodiment of the camera body cap system.

FIG. 9 shows a side view of the second exemplary embodiment of the camera body cap system.

FIG. 10 shows a cross-sectional view of the second exemplary embodiment of the camera body cap system taken from line 10-10 as shown in FIG. 9.

FIG. 11 shows an exploded view of the second exemplary embodiment of the camera body cap system.

FIG. 12 shows the second exemplary embodiment of the camera body cap system with a top cap.

FIGS. 13A and 13B show a side view of the tubular component of the second exemplary embodiment (FIG. 13A) and a cross-sectional view taken from line 13B-13B of the side view (FIG. 13B).

FIGS. 14A and 14B show a rear view (FIG. 14A) and side view (FIG. 14B) of the base component of the second exemplary embodiment of the camera body cap system.

FIG. 15 shows a top view of the air output check valve of the second exemplary embodiment of the camera body cap system.

FIG. 16 shows a perspective view of a third exemplary embodiment of the camera body cap system.

FIG. 17 shows an exploded view of the third embodiment of the camera body cap system.

FIG. 18 is a schematic showing air flow when the air bulb is depressed in the third exemplary embodiment.

FIG. 19 is a schematic showing air flow when the air bulb is released in the third exemplary embodiment.

FIG. 20 shows an exploded view of a fourth exemplary embodiment of the camera body cap system.

FIG. 21 is a schematic showing air flow when the air bulb is depressed in the fourth exemplary embodiment.

FIG. 22 is a schematic showing air flow when the air bulb is released in the fourth exemplary embodiment.

### DETAILED DESCRIPTION

Disclosed herein is a camera body cap system for removing contaminants from an interior of a camera body. The system comprises a camera body cap configured to attach the system to the camera body, an air bulb for generating air flow, an air intake structure configured to filter the incoming air and direct the air flow into the interior of the camera body, and an air output structure configured to allow air to exit the camera interior and leave the system. The system directs air into the interior of the camera body at increased velocity, pressure, and force sufficient to dislodge dirt and dust adhered to, resting on, or statically attached to the front surface of the sensor, after which the airflow carries the dislodged debris out of the interior of the camera body.

In one version of the system, the air bulb is an external bulb that is temporarily coupled to the system during use. In this version, the system includes an airflow module coupled to the camera body cap to form air intake and air output structures. The airflow module comprises: (i) an intake check valve configured to permit airflow toward the interior of the camera body and to inhibit backflow; (ii) an air intake filter positioned to remove contaminants from incoming air; and (iii) at least one sensor channel disposed downstream of the air intake filter and configured to deliver the filtered air into the interior of the camera body. The air output structure may include one or more output channels associated with the airflow module and/or the camera body cap, and may optionally include a one-way valve to prevent backflow. In this version, airflow is unidirectional: air provided by the external air bulb is filtered, directed into the camera interior, and then discharged through the output structure.

In another version of the system, the air bulb is mounted to the camera body cap, and a filter frame is mounted and sealed to the camera body cap and the air bulb to form an air chamber. In this version, the filter frame includes a base having at least one sensor channel configured to deliver air into the interior of the camera body. The system further includes at least one cap intake/output channel extending through a side wall of the camera body cap, and an air intake filter positioned between the cap intake channel and the filter frame. This version operates as a bidirectional airflow system. When the air bulb is depressed, air is forced through the sensor channel into the camera interior and exits through the cap intake/output channel. When the air bulb is released, air enters through the intake channel, passes through the intake filter, and fills the air chamber with filtered air.

Provided below are exemplary embodiments intended to illustrate features of the disclosed camera body cap system and to facilitate understanding. Embodiments 1 and 2 correspond to the first version of the system. In Embodiment 1, components of the airflow module are arranged such that the camera body cap is positioned between them, whereas in Embodiment 2, the airflow module is mounted to an outer surface of the camera body cap. Exemplary embodiments of the second version of the system are set forth in Embodiments 3 and 4. These embodiments are provided for illustrative purposes only and are not intended to limit the disclosure to the specific configurations shown. The shapes, dimensions, and coupling mechanisms of the components are also illustrative and should not be construed as limiting. Various modifications, substitutions, and alterations may be made without departing from the scope of the disclosure as defined by the appended claims.

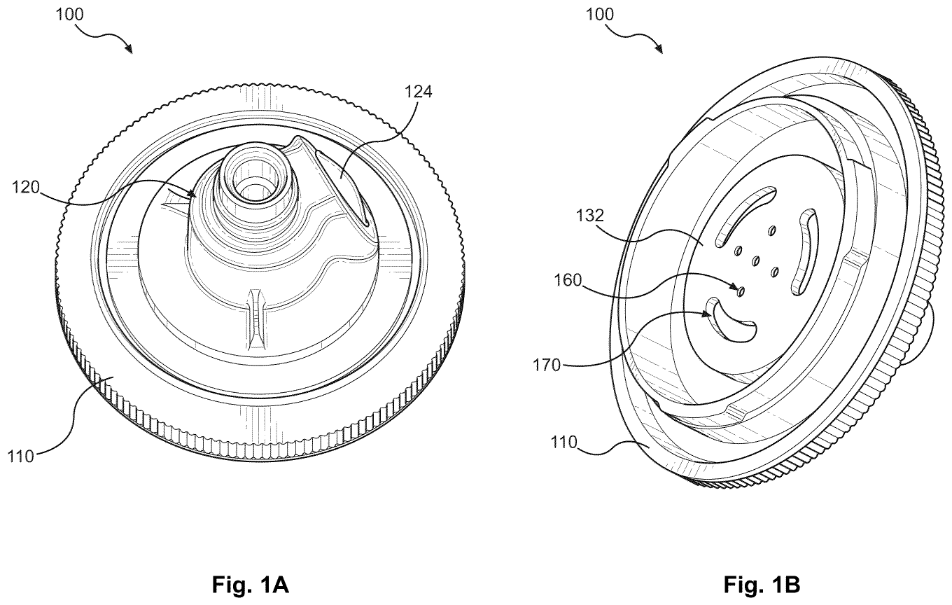

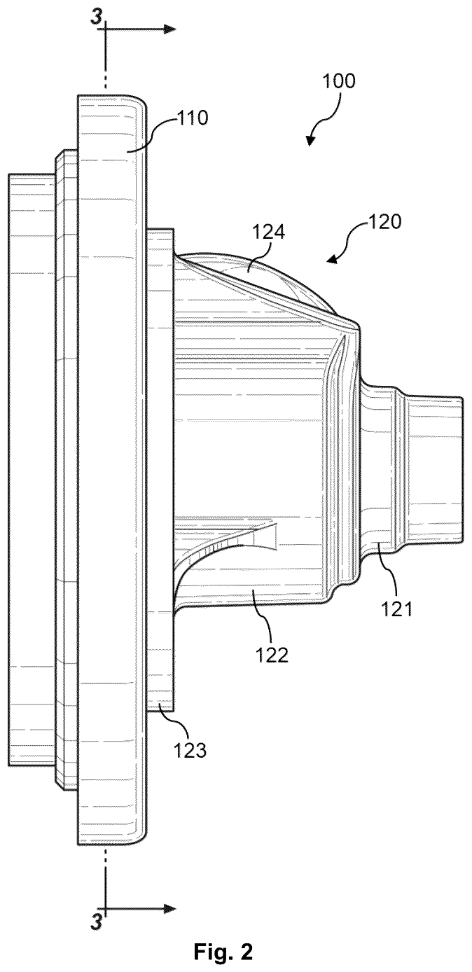

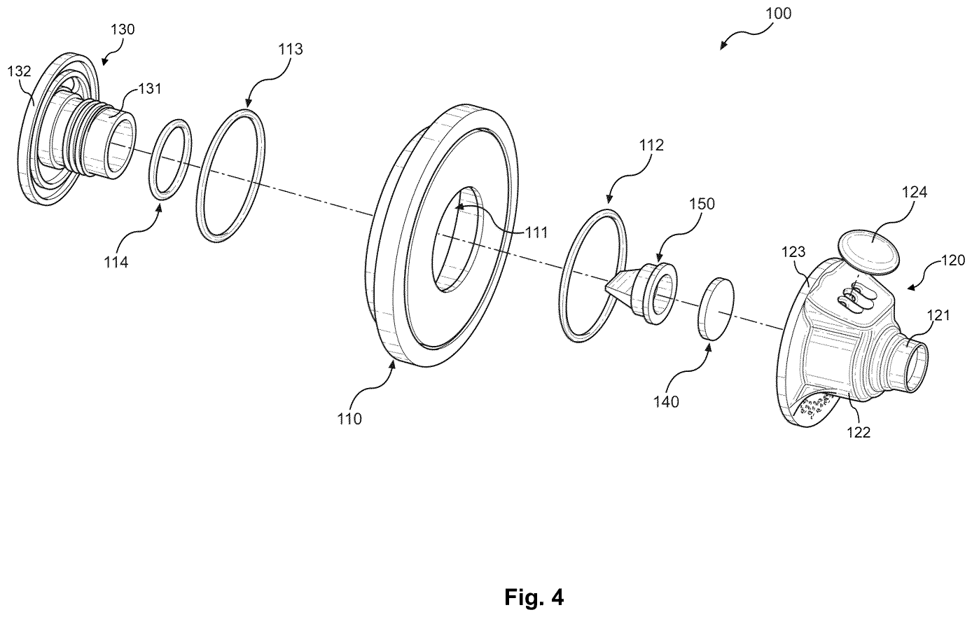

Referring to FIGS. 1-7, a first exemplary embodiment of the camera body cap system 100 comprises a camera body cap 110 having an aperture 111 and configured to removably attach the system 100 to the camera body. The system 100 may be fabricated with camera body caps 110 adapted to engage different camera mounts so that the system can be used with a variety of camera bodies from different manufacturers. The camera body cap 110 may be fabricated specifically as a part of the system 100. Preferably, the camera body cap 110 is an off-the-shelf component with the aperture 111 created through the camera body cap 110, allowing the system 100 to be able to attach to any of the corresponding cameras, including any interchangeable lens such as single-lens (SL) and mirrorless cameras. The aperture 111 may be formed using any suitable material removal technique known in the art, such as drilling, punching, or cutting.

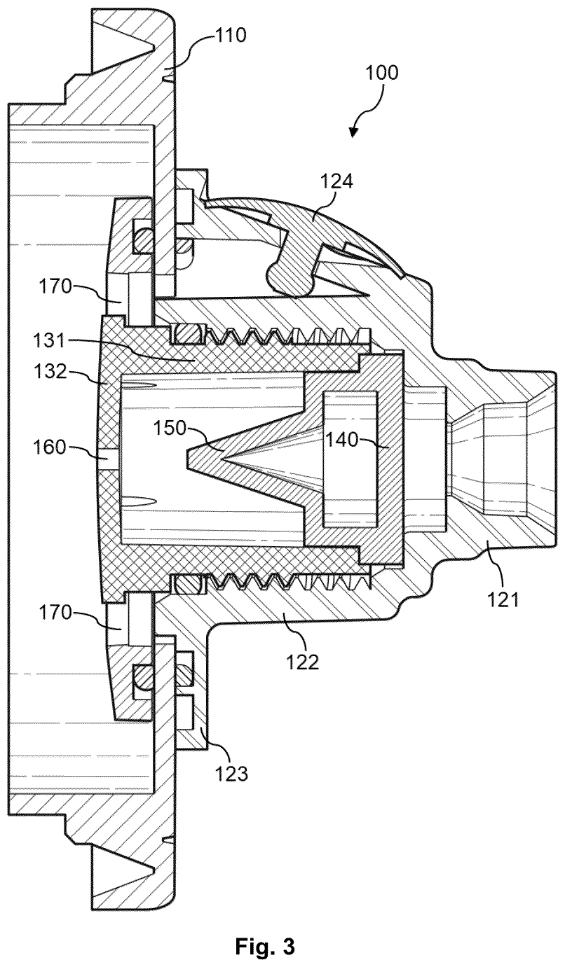

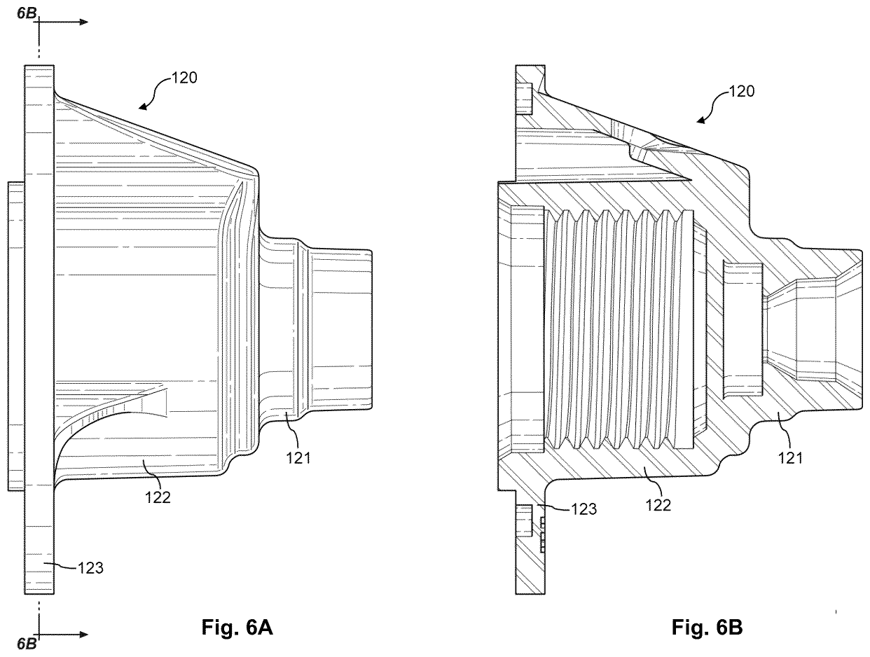

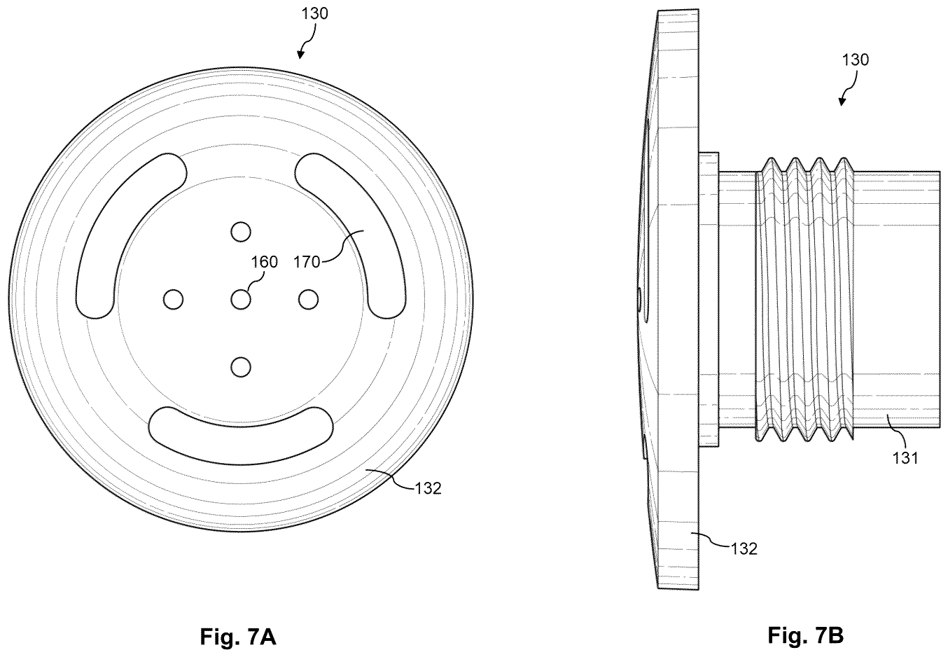

As shown in FIGS. 1-4, the system 100 further comprises a first tubular component 120 and a second tubular component 130. The first and second tubular components 120 and 130 are both hollow structures. The first tubular component 120 comprises a first tubular section 121, a second tubular section 122, and a base 123 (FIGS. 6A and 6B). The second tubular component 130 comprises a tubular section 131 and a base 132 (FIGS. 7A and 7B). The tubular section 131 of the second tubular component 130 is configured to fit into the aperture 111 of the camera body cap 110 and into the second tubular section 122 of the first tubular component 120, such that the tubular section 131, after passing through the aperture 111, is connected (e.g., threaded) into the second tubular section 122 (FIG. 3). This assembly forms a unified airflow module of the system 100. FIGS. 1A and 1B show front and rear perspective views of the assembled system 100. As shown, the base 123 of the first tubular component 120, the camera body cap 110, and the base 132 of the second tubular component 130 are tightly joined together. An air intake filter 140 and an intake check valve 150 are housed within the assembled tubular structure. The first tubular section 121 of the first tubular component 120 has a smaller diameter than the second tubular section 122, and the air intake filter 140 fits precisely within the assembled tubular section, such that the air intake filter 140 is secured at the junction between the first and second tubular sections 121 and 122. The air intake filter 140 functions to retain contaminants from the air flowing through the intake check valve 150. The intake check valve 150 may be a duckbill valve or any other type of check valve known in the art that is suitable for insertion into the assembly. Preferably, but not required, O-Rings 112, 113, and 114 are included between the first tubular component 120 and the camera body cap 110, and between the camera body cap 110 and the second tubular component 130, enhancing sealing of the system.

The second tubular component 130 further comprises at least one sensor channel 160 extending through the base 132 (FIG. 7A), through which air is directed from the assembled tubular structure into the interior of the camera body. The sensor channel 160 functions as air jets that dislodge contaminants from interior camera components. The sensor channel 160 may be numbered, angled, spaced, and/or otherwise arranged to provide airflow to the entire sensor surface or camera interior.

The second tubular component 130 further comprises at least one output channel 170 extending through the base 132 and positioned radially outward of the sensor channel 160, in a region of the base 132 located beyond an area corresponding to the tubular section 131 (FIG. 7A). The output channel 170 allows air to escape from the camera body cavity.

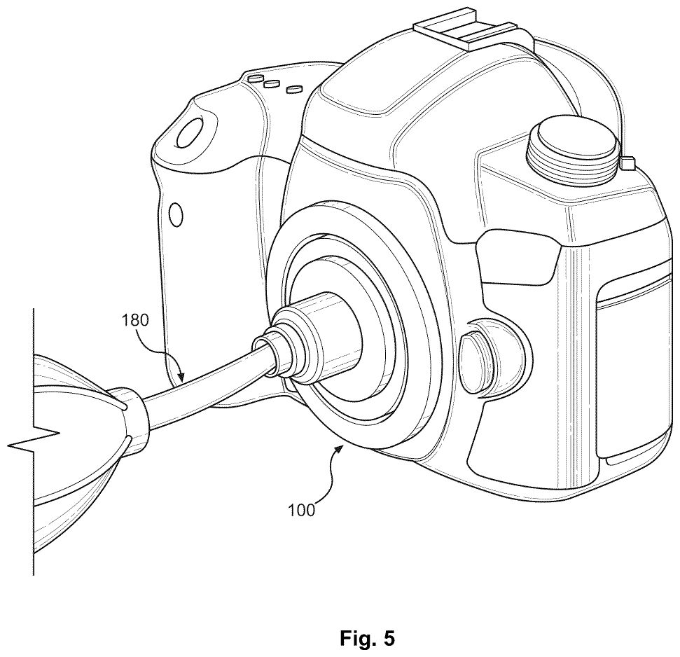

FIG. 5 shows the system 100 installed on a camera and working with an external air bulb 180. During use, the tip of the external air bulb 180 is temporarily inserted into the first tubular section 121 of the first tubular component 120 and depressed to produce air flow. The incoming air passes through the air intake filter 140, the intake check valve 150, the assembled tubular channel, and the sensor channel 160 that extend through the base 132 of the second tubular component 130, thereby delivering filtered air into the interior of the camera body. As described above, the assembled tubular channel is formed by passing the tubular section 131 of the second tubular component 130 through the aperture 111 of the camera body cap 110 and threading it into the second tubular section 122 of the first tubular component 120. The resulting airflow removes contaminants from components in the interior of the camera body and exits the camera body cavity through the output channel 170 extending through the base 132 of the second tubular component 130. The intake check valve 150 ensures one-directional airflow by preventing backflow from the output channel 170. As a result, all incoming air that enters through the intake check valve 150 is filtered, while all outgoing air is expelled through the output channel 170. In certain embodiments, the first tubular component 120 further comprises an umbrella check valve 124 configured to release excess pressure generated by the external air bulb 180. After each burst of air, the external air bulb 180 is withdrawn from the first tubular section 121 to allow the bulb to refill with air. The cleaning process may then be repeated by reinserting the tip of the air bulb into the first tubular section 121 and depressing the bulb again.

The external air bulb 180 may be fabricated specifically for the system 100. For example, the air bulb may be constructed from a flexible material that is at least partially impermeable to gas, allowing air to be drawn into the bulb when released and expelled when depressed. Suitable materials include, but are not limited to, polymeric materials, elastomeric materials, metallic materials, or combinations thereof. In embodiments utilizing elastomeric materials, the bulb may self-inflate with air after each compression expels previously filtered air. In various embodiments, the bulb may be sized and shaped so that it can be depressed with a single finger. In preferred embodiments, the external air bulb 180 is an off-the-shelf hand operated air bulb commonly used for cleaning camera sensors, such that the system 100 can function with any standalone air bulbs known in the art.

The air intake filter 140 may be constructed from a porous material capable of removing contaminants from air passing through it. Such materials may include, but are not limited to, polymeric foams, polymeric fibers, metallic fibers, filter paper, or combinations thereof.

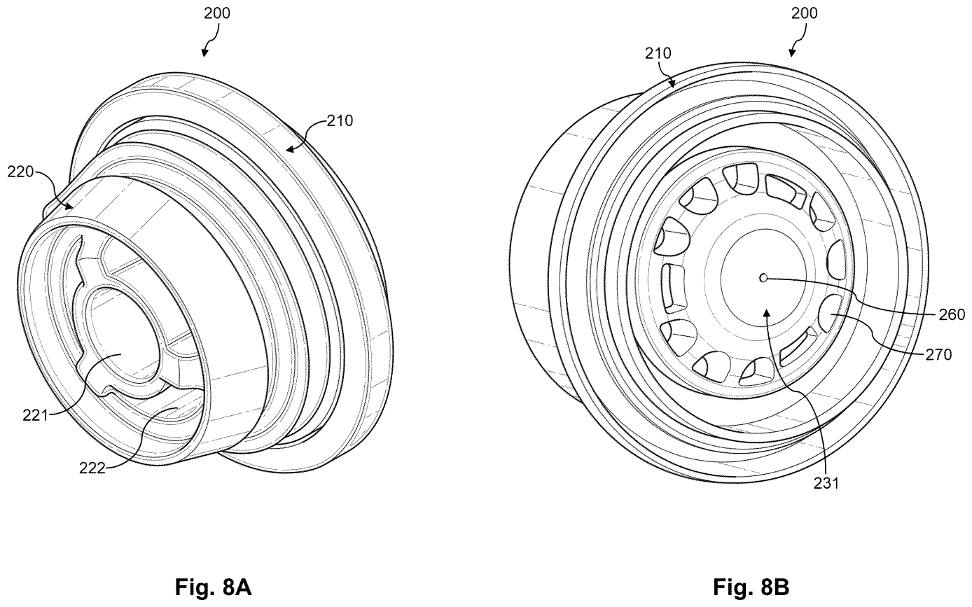

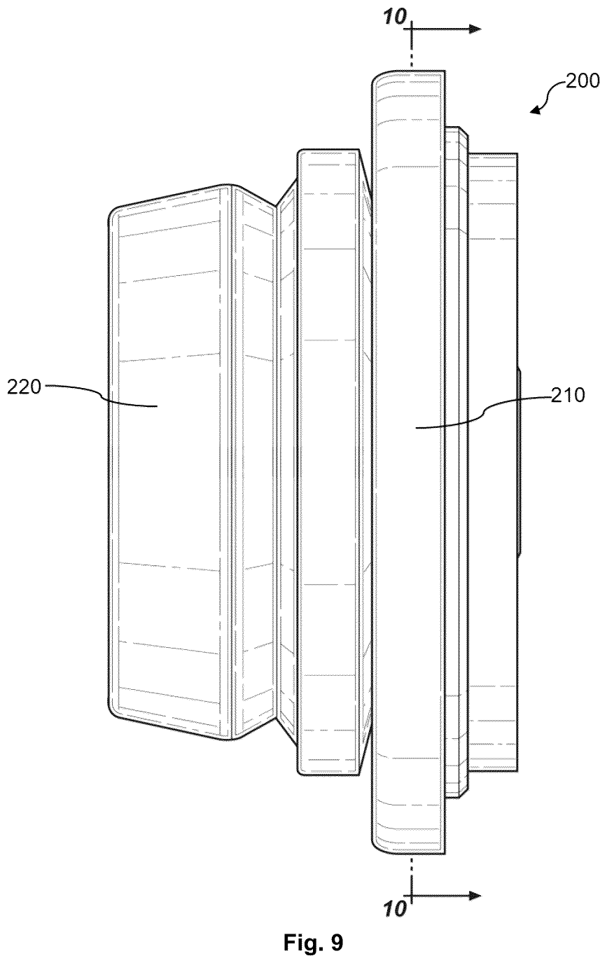

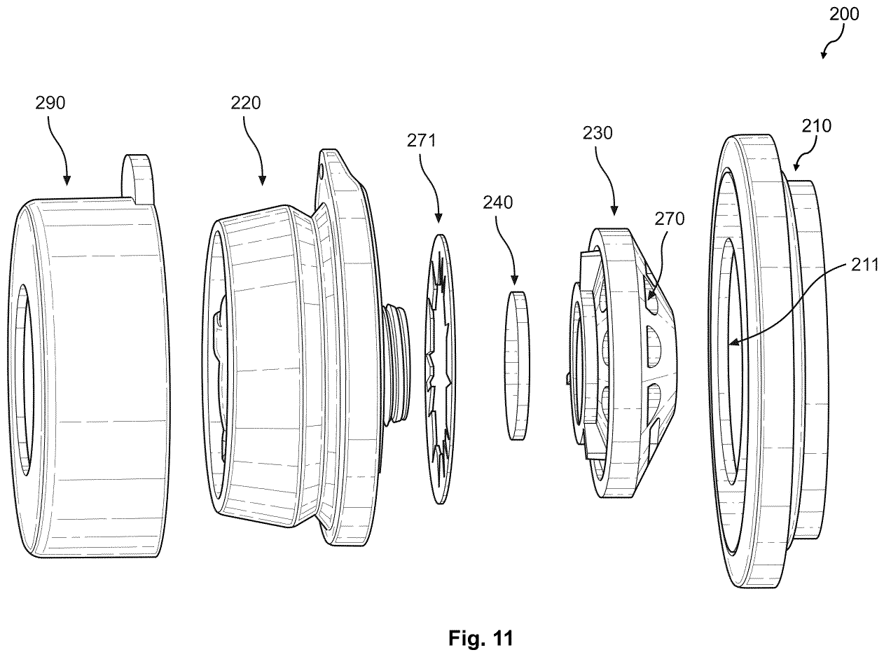

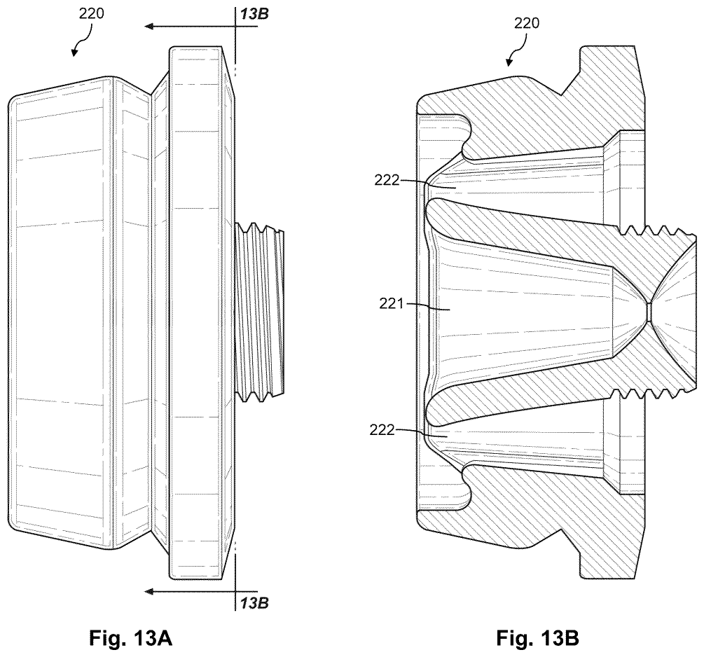

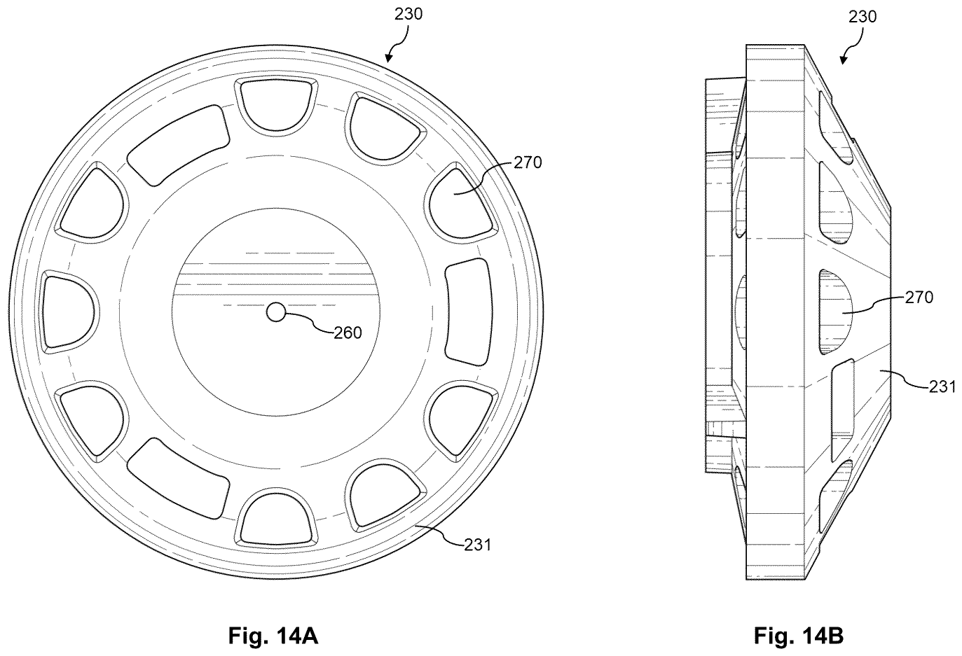

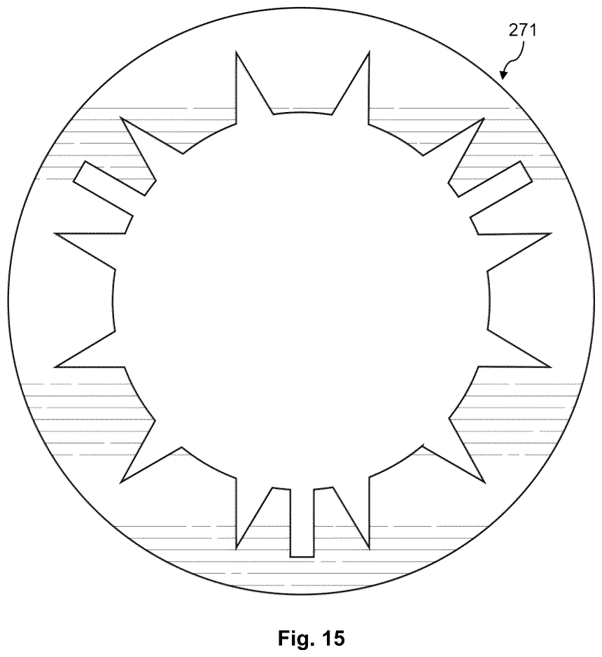

Referring to FIGS. 8-15, a second exemplary embodiment of the camera body cap system 200 comprises a camera body cap 210 having an aperture 211 and configured to removably attach the system 200 to the camera body. The system 200 may be fabricated with camera body caps 210 adapted to engage different camera mounts so that the system can be used with a variety of camera bodies from different manufacturers. In certain embodiments, the camera body cap 210 may be fabricated specifically as a part of the system 200. In other embodiments, the camera body cap 210 is an off-the-shelf component, with the aperture 211 created through the cap by any suitable material removal technique, such as drilling, punching, or cutting.

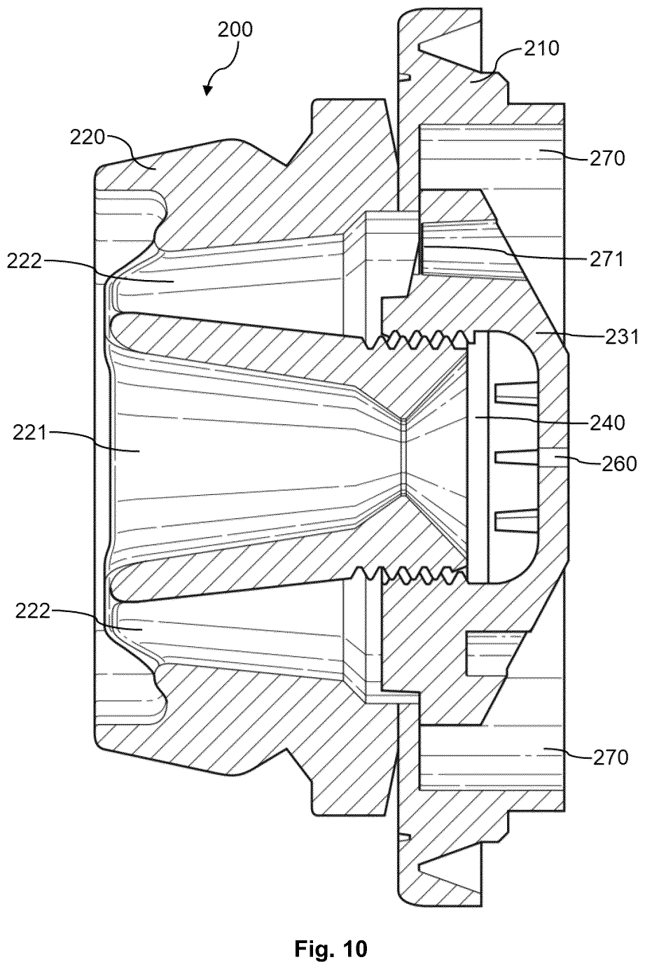

The system 200 further comprises an airflow module mounted on an outer surface of the camera body cap 210. The airflow module comprises a tubular component 220 and a base component 230 coupled together (e.g., by a threaded engagement; FIG. 10). The tubular component 220 comprises, on its outer side, an air intake channel 221 configured to receive incoming air flow from an external air bulb when the air bulb is depressed. Optionally, the air intake channel 221 may house an intake check valve, such as a duckbill check valve or any other types of check valves known in the art that is suitable for insertion into the air intake channel 221. The base component 230 comprises at least one sensor channel 260 extending through the base 231. The sensor channel 260 is positioned to align with the aperture 211 of the camera body cap 210, allowing air to flow into the interior of the camera body through the sensor channel 260 and the aperture 211. The sensor channel 260 functions as air jets that direct airflow across interior components of the camera to dislodge contaminants. The sensor channel 260 may be numbered, angled, spaced, and/or otherwise arranged to provide airflow to the entire sensor surface or camera interior. An air intake filter 240 is mounted to the base component 230 between the air intake channel 221 and the sensor channel 260 to remove contaminants from the air passing through the air intake channel 221 (FIG. 10). The system 200 further comprises at least one output channel 270 extending through the base 231 of the base component 230 and at least one output channel 222 extending through the tubular component 221. The output channel 270 is positioned radially outward of the sensor channel 260, and the output channel 222 is positioned radially outward of the air intake channel 221. In this particular embodiment, an output check valve 271 is positioned outward to the output channel 270 to allow air to exit the camera body cavity while preventing backflow.

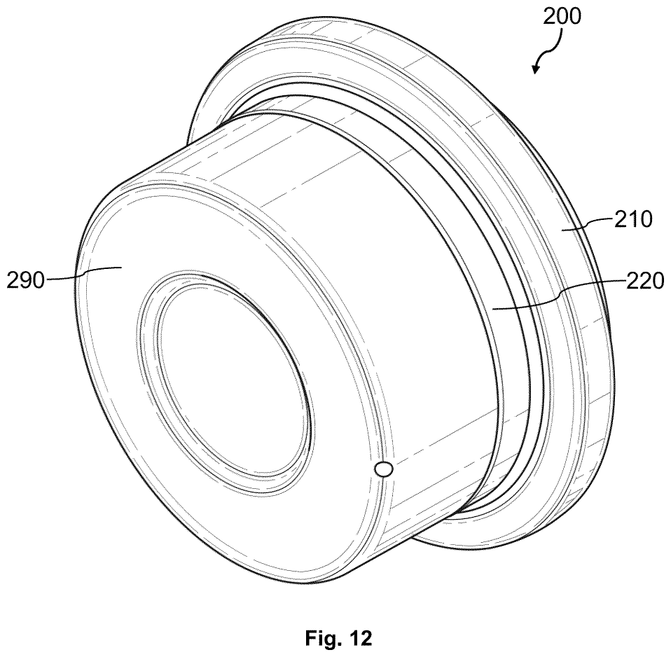

Optionally, the system 200 further comprises a top cap 290 coupled to the tubular component 220 to prevent contaminants from entering the system 200 when it is not in use (FIG. 12).

When in use, the tip of the external air bulb is temporarily inserted into the air intake channel 221 and the bulb is depressed to produce air flow into the interior of the camera body through the air intake channel 221, the air intake filter 240, the sensor channel 260, and the aperture 211 of the camera body cap 210. The air flow removes contaminants from components within the interior of the camera body and then exits the camera body cavity through the output channel 270, check valve 271, and output channel 222. The check valve 271 ensures the air flows in one direction and prevents backflow through the output channels. This design prevents contaminants from entering the interior of the camera, as all incoming air passes through the air intake channel 221 is filtered, while all outgoing air is expelled through the output check valve 271. After each burst of air, the external air bulb is withdrawn from the air intake channel 221 to allow the bulb to refill with air. The cleaning process may then be repeated by reinserting the tip of the air bulb into the air intake channel 221 and depressing the bulb again.

The external air bulb and the air intake filter 240 may be fabricated from materials similar to those used for the air bulb 180 and the air intake filter 140. Various embodiments of the system 200 may be used with different external air bulbs. In one embodiment, the external air bulb may be fabricated specifically for the system 200. In another embodiment, the external air bulb is an off-the-shelf hand operated air bulb commonly used for cleaning camera sensors, such that the system 200 can function with any standalone air bulbs known in the art.

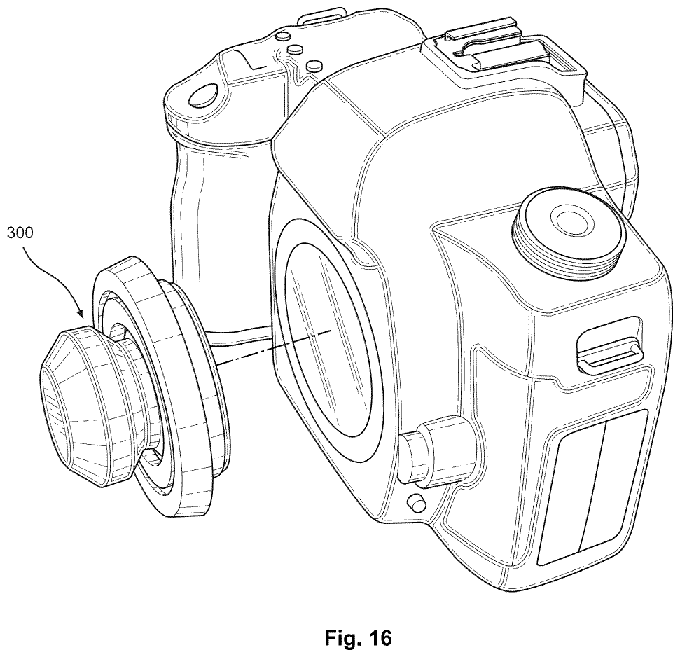

Referring to FIGS. 16-19, a third exemplary embodiment of the camera body cap system 300 comprises a camera body cap 310 connecting the system 300 to the camera body. The system 300 may be fabricated with camera body caps 310 adapted to engage different camera mounts so that the system can be used with a variety of camera bodies from different manufacturers. In certain embodiments, the camera body cap 310 may be fabricated specifically as a part of the system 300. In other embodiments, the camera body cap 310 is an off-the-shelf component with at least one aperture 311 created through the cap by any suitable material removal technique, such as drilling, punching, or cutting.

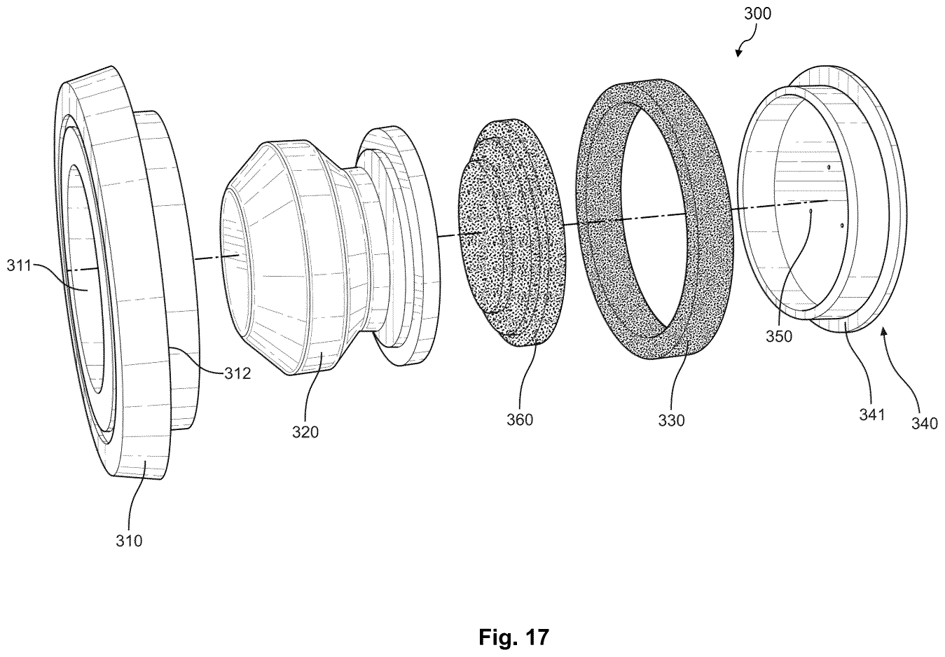

As shown in FIGS. 17-19, at least one cap intake channel 312 extends through the camera body cap 310 to connect the interior of the camera body with the outer atmosphere. A bulb 320 extends through the aperture 311 of the camera body cap 310 and, when depressed or released, generates air flow through the cap intake channel 312. An air intake filter 330, mounted to a filter frame 340, removes contaminants from the air drawn through the cap intake channel 312. The camera body cap 310 and the bulb 320 are mounted and sealed to the filter frame 340, thereby forming an air chamber 321. The filter frame 340 further includes at least one sensor channel 350 extending through its base 341, allowing air to flow into or out of the bulb 320 and across components within the interior of the camera body when the bulb 320 is depressed or released, respectively. The resulting air flow dislodges and removes contaminants from internal camera components, while the system 300 also prevents contaminants from entering the interior of the camera body when not in use. This configuration provides a closed loop, filtered air system that ensures the cleaning airflow does not introduce new contaminants.

The system 300 may further comprise a secondary air filter 360 positioned between the sensor channel 350 and the interior of the bulb 320. The secondary air filter 360 provides additional filtration of the air flow and may be constructed from any of the materials used for the air intake filter 330.

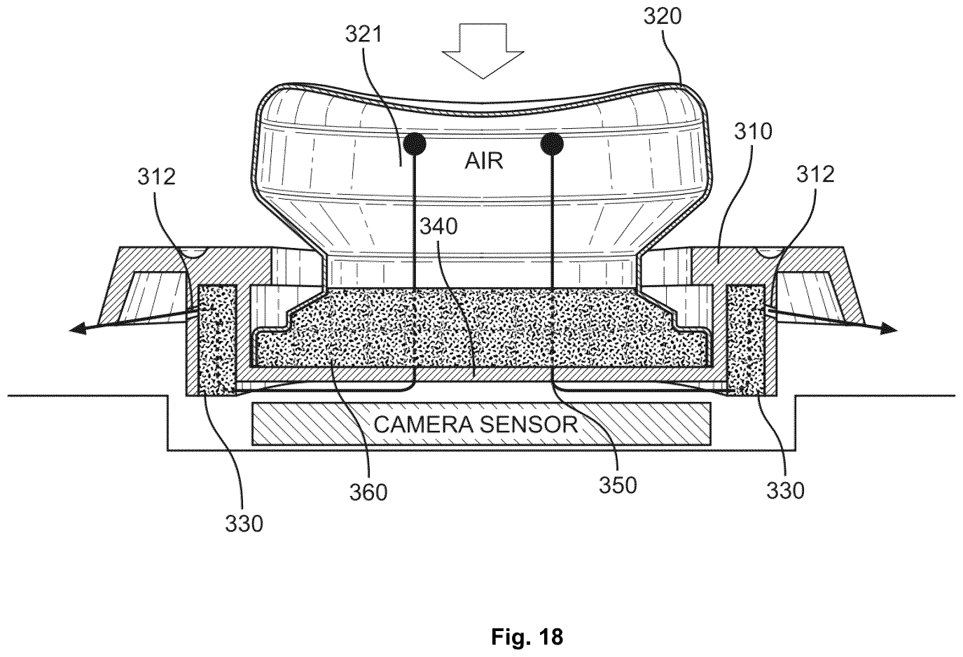

As shown in FIG. 18, when the system 300 is mounted to the camera body, depressing the bulb 320 forces air out of the bulb 320 through the secondary air filter 360 and the sensor channels 350, thereby directing air flow over components in the interior of the camera body and dislodging contaminants from the components. The sensor channels 350 function as air jets that blow contaminants off the sensor and other interior surfaces. The sensor channels 350 may be numbered, angled, spaced, and/or otherwise arranged to provide airflow to the entire sensor surface or camera interior.

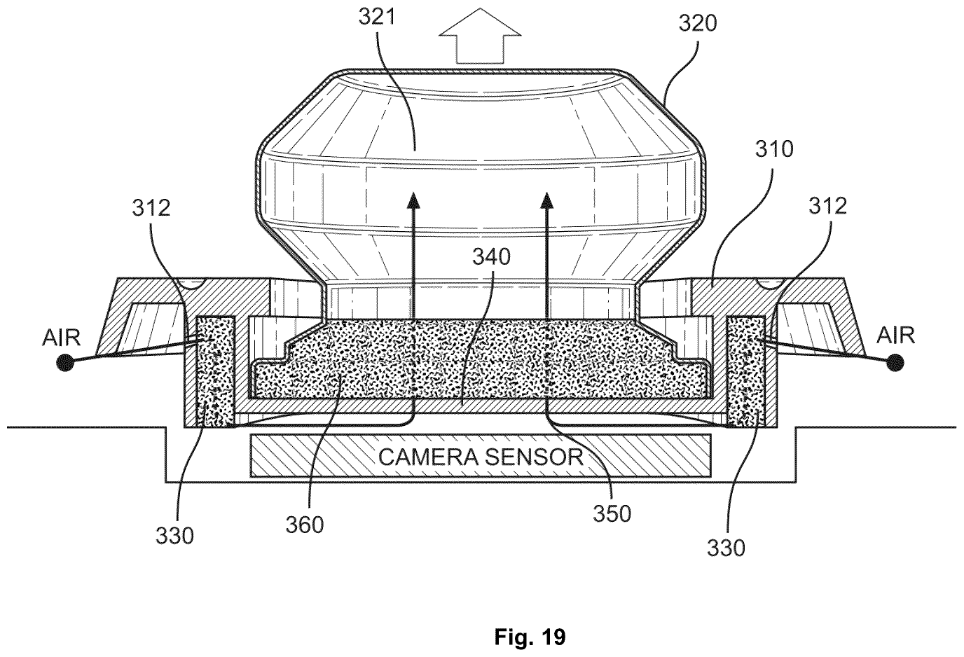

As shown in FIG. 19, when the bulb 320 is released, air is drawn into the bulb 320 from the cap intake channel 312, through the air intake filter 330, the sensor channels 350, and the secondary air filter 360, thereby again directing air flow across interior camera components and dislodging contaminants.

The external air bulb 320, the air intake filter 330, and the secondary air filter 360 may be fabricated from materials similar to those used for the air bulb 180 and the air intake filter 140. As noted above, the camera body cap 310 may be an off-the-shelf component modified to accommodate the system 300. In particular, at least one central aperture 311 is formed through the camera body cap 310 by removing cap material. The resulting central aperture 311 can receive portions of the system 300, including, but not limited to, the bulb 320. The remaining components of the system 300, such as the air intake filter 330, the filter frame 340, and other associated elements, may be configured to snap into place within the camera body cap 310. This configuration allows the system 300 to be used with any camera body cap 310 designed to attach to a corresponding camera, provided that the camera body cap 310 can accommodate the central aperture 311.

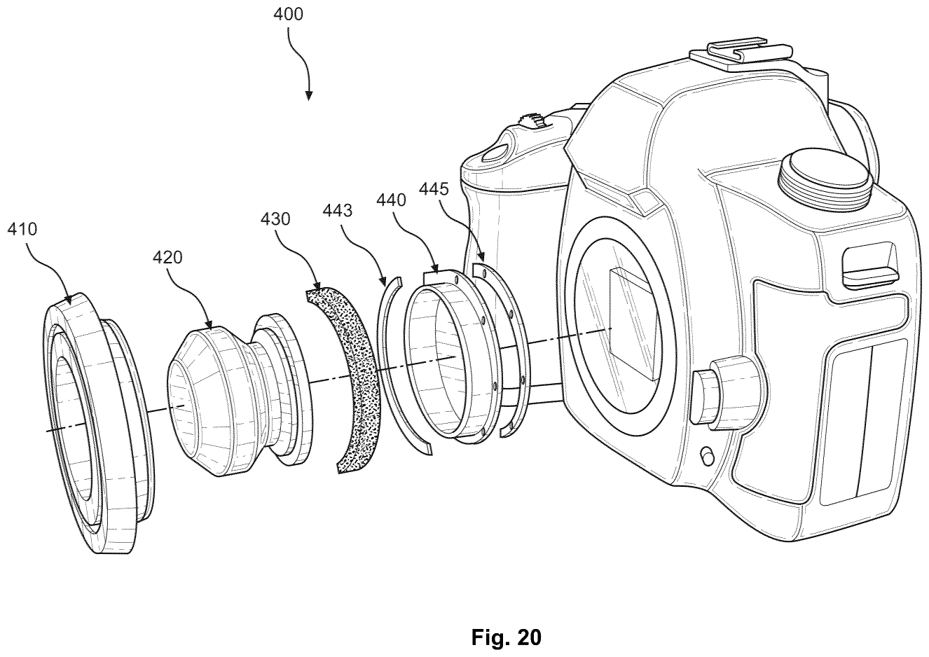

Referring to FIGS. 20-22, a fourth exemplary embodiment of the camera body cap system 400 comprises a camera body cap 410 configured to connect the system 400 to the camera body. Similar to the third exemplary embodiment, the system 400 comprises at least one cap intake channel 412, an air bulb 420, an air intake filter 430, a filter frame 440, and one or more sensor channels 450. In this embodiment, however, air flow is directed along a flow path through the use of one-way valves. The system 400 additionally includes at least one cap output channel 413 formed in the camera body cap 410, which is configured to exhaust air and entrained contaminants from the camera interior.

To direct the air flow, the filter frame 440 incorporates at least one frame intake channel 442 covered by an intake valve 443, and at least one frame output channel 444 covered by an output valve 445. Both the intake valve 443 and the output valve 445 are one-way valves. During operation, positive pressure caused by depressing the bulb 420 closes the intake valve 443 and opens the output valve 445, thereby expelling air and entrained contaminants from the system 400. Conversely, negative pressure caused by releasing the bulb 420 opens the intake valve 443 and closes the output valve 445, allowing filtered air to enter the system. Because incoming air enters exclusively through the frame intake channel 442 and the associated intake valve 443, the air intake filter 430 only needs to be positioned between the cap intake channel 412 and the frame intake channel 442.

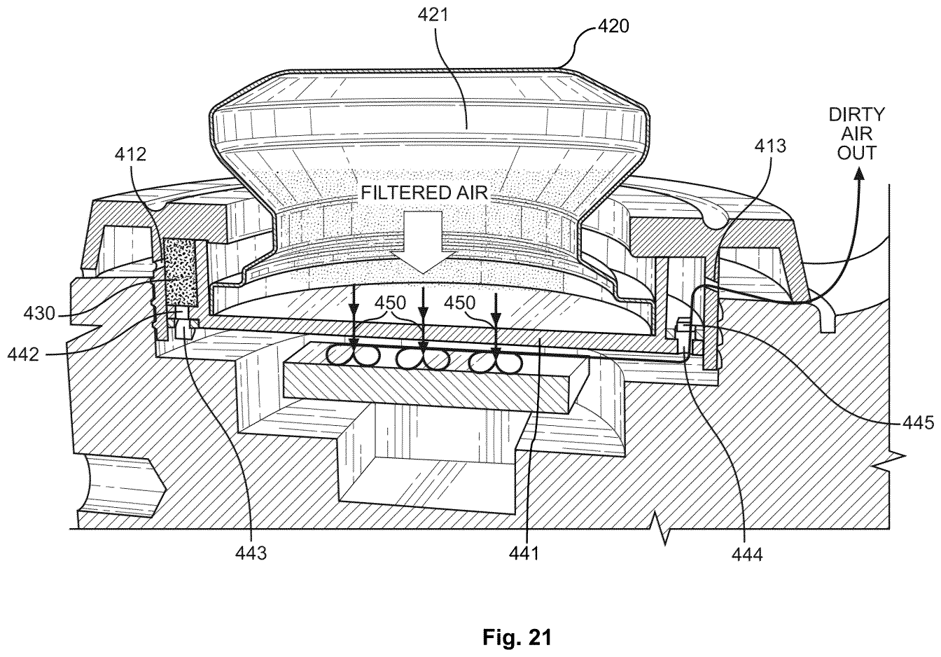

As shown in FIG. 21, depressing the bulb 420 forces air out of the bulb 420 and through the sensor channels 450, directing the air flow over components within the interior of the camera body and dislodging contaminants from the components. The resulting air flow, carrying entrained contaminants, then exits the camera body through the frame output channel 444, the output valve 445, and the cap output channel 413. Under the positive pressure created by depressing the bulb, the output valve 445 is held open, while the intake valve 443 remains closed.

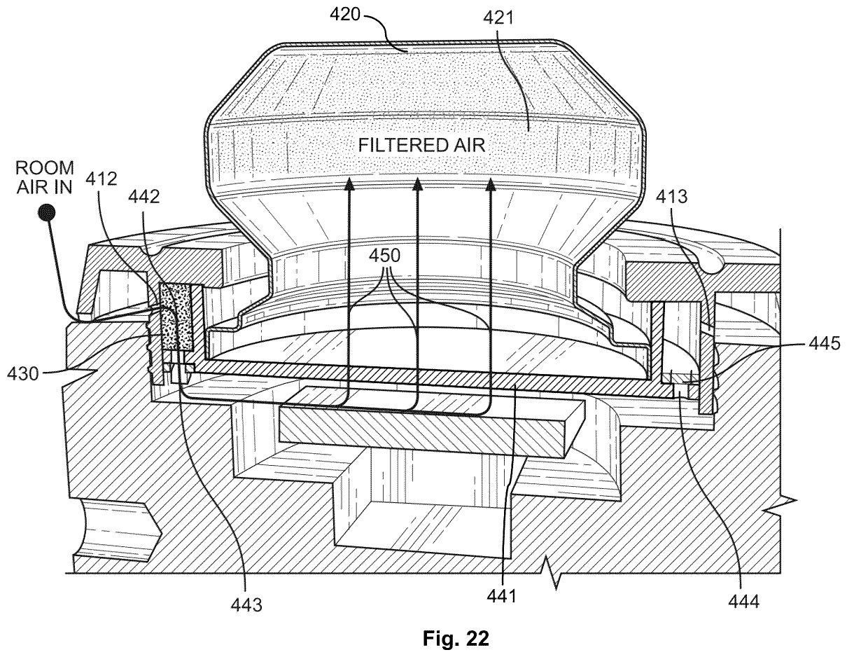

As shown in FIG. 22, when the bulb 420 is released, air is drawn into the bulb 420 from the cap intake channel 412, through the air intake filter 430, the frame intake channel 442, the intake valve 443, and the sensor channels 450, such that air flows over components in the interior of the camera body, again dislodging contaminants from the components. The intake valve 443 is held open by the negative pressure created during release of the bulb 420, while the output valve 445 remains closed.

Because all incoming air enters through the one-way intake valve 443 and is filtered, and all outgoing air is expelled through the one-way output valve 445, the system minimizes the introduction of contaminants into the camera body.

In the foregoing description, certain terms have been used for brevity, clarity, and understanding. No unnecessary limitations are to be inferred therefrom beyond the requirement of the prior art because such terms are used for descriptive purposes and are intended to be broadly construed. The different configurations and systems described herein may be used alone or in combination with other configurations and systems. It is to be expected that various equivalents, alternatives and modifications are possible within the scope of the foregoing description.

As used herein, the terms “inner” and “outer” are used for convenience to describe relative orientation of components of the system. “Inner” refers to a side, surface, or direction facing toward or adjacent to the interior of the camera body when the camera body cap system is attached. “Outer” refers to a side, surface, or direction facing away from the camera interior and toward the external environment. These terms are used descriptively and are not intended to impose absolute or limiting spatial requirements on the claimed structures.

Any version of any component of the disclosure may be used with any other component of the disclosure. The elements described herein can be used in any combination whether explicitly described or not.

As used herein, the singular forms “a,” “an,” and “the” include plural referents unless the content clearly dictates otherwise.

As used herein, the term “or” is an inclusive “or” operator and is equivalent to the term “and/or” unless the context clearly dictates otherwise.

The systems of the present disclosure can comprise, consist of, or consist essentially of the essential elements and limitations described herein, as well as any additional or optional components, or limitations described herein or otherwise useful in the art. The disclosure provided herein suitably may be practiced in the absence of any element which is not specifically disclosed herein.

While this disclosure may be embodied in many forms, what is described in detail herein is a specific preferred embodiment of the disclosure. The present disclosure is an exemplification of the principles of the disclosure and is not intended to limit the disclosure to the particular embodiments illustrated. It is to be understood that this disclosure is not limited to the particular examples, configurations, and materials disclosed herein as such configurations and materials may vary somewhat. It is also understood that the terminology used herein is used for the purpose of describing particular embodiments only and is not intended to be limiting since the scope of the present disclosure will be limited to only the appended claims and equivalents thereof.

What is claimed is:

1. A system for removing contaminants from an interior of a camera body, comprising:
(a) a camera body cap configured to be removably attached to the camera body, the camera body cap having an aperture extending therethrough;
(b) an airflow module coupled to the camera body cap, the airflow module cooperating with the aperture of the camera body cap to form an air intake path configured to receive airflow from an external air bulb and direct the airflow toward the interior of the camera body,
the airflow module comprising:
(i) an air intake channel configured to receive airflow from the external air bulb;
(ii) an air intake filter positioned to remove contaminants from incoming air; and
(iii) at least one sensor channel disposed downstream of the air intake filter and configured to deliver the filtered air into the interior of the camera body; and
(c) at least one air output channel structurally associated with the airflow module and/or the camera body cap, and configured to allow air to exit from the interior of the camera body.

2. The system of claim 1, wherein the air intake channel houses an air intake check valve configured to permit airflow toward the interior of the camera body and to inhibit backflow.

3. The system of claim 2, wherein the air intake check valve is positioned upstream of the air intake filter.

4. The system of claim 2, wherein the air intake check valve is positioned downstream of the air intake filter.

5. The system of claim 1, further comprising an output check valve positioned to prevent backflow of air through the air output channel.

6. The system of claim 1, wherein components of the airflow module are arranged on opposite sides of the camera body cap, and the at least one sensor channel is located downstream of the aperture.

7. The system of claim 6, wherein the airflow module comprises a first tubular component and a second tubular component, each having a hollow interior, wherein:
the first tubular component comprises a first tubular section, a second tubular section, and a base;
the second tubular component comprises a tubular section and a base configured to face the interior of the camera body; and
the tubular section of the second tubular component extends through the aperture of the camera body cap and engages the second tubular section of the first tubular component to form the airflow module.

8. The system of claim 7, wherein the air intake filter is positioned at a junction between the first tubular section and the second tubular section of the first tubular component, and the airflow module further comprises an air intake check valve disposed within the assembled tubular components in the airflow path downstream of the air intake filter.

9. The system of claim 7, wherein the at least one sensor channel extends through a base of the second tubular component, and the at least one air output channel extends through the base of the second tubular component at a position radially outward of the at least one sensor channel.

10. The system of claim 7, further comprising an umbrella check valve disposed within the first tubular component and configured to release excess pressure generated by the external air bulb.

11. The system of claim 1, wherein the airflow module is attached to an outer surface of the camera body cap such that the at least one sensor channel is located upstream of, or in parallel with, the aperture.

12. The system of claim 11, wherein the airflow module comprises:
a tubular component comprising the air intake channel configured to receive the external air bulb;
a base component coupled to the tubular component, the base component comprising at least one sensor channel extending through the base component and aligned with the aperture of the camera body cap;
at least one air output channel extending through the tubular component and positioned radially outward of the air intake channel; and
at least one air output channel extending through the base component and positioned radially outward of the at least one sensor channel;
wherein the air intake filter is positioned between the air intake channel and the at least one sensor channel.

13. The system of claim 12, further comprising an air output check valve positioned outward to the air output channel of the base component and configured to prevent backflow of air through the air output channel of the base component.

14. A system for removing contaminants from an interior of a camera body, comprising:
(a) a camera body cap configured to be removably attached to the camera body, the camera body cap having an aperture extending therethrough and at least one cap intake channel extending therethrough;
(b) a flexible bulb extending through the aperture of the camera body cap;
(c) a filter frame coupled and sealed to the camera body cap and the air bulb, such that the camera body cap, the air bulb, and the filter frame together form an air chamber;
(d) an air intake filter positioned between the at least one cap intake channel and the filter frame to remove contaminants from air drawn through the cap intake channel; and
(e) at least one sensor channel extending through a base of the filter frame and configured to place the air chamber in fluid communication with the interior of the camera body;
wherein depression of the air bulb generates airflow from the air chamber through the sensor channel into the interior of the camera body and expels air therefrom, and release of the air bulb draws air through the cap intake channel, the air intake filter, and the sensor channel into the air chamber.

15. The system of claim 14, further comprising a secondary air filter positioned between the air chamber and the at least one sensor channel.

16. The system of claim 14, wherein the at least one cap intake channel is configured to conduct airflow out of the interior of the camera body during depression of the air bulb and to conduct airflow into the air chamber during release of the air bulb.

17. The system of claim 14, further comprising at least one frame intake channel extending through the filter frame, and an intake valve positioned along the frame intake channel and configured to allow airflow into the air chamber during release of the air bulb and inhibit airflow during depression of the air bulb.

18. The system of claim 14, further comprising at least one frame output channel extending through the filter frame, and an output valve positioned along the frame output channel and configured to allow air to exit the camera body during depression of the air bulb and inhibit airflow during release of the air bulb.
